(19) United States
(12) Patent Application Publication
(10) Pub. No.: US 2008/0122143 A1
(43) Pub. Date: May 29, 2008

(54) APPARATUS, SYSTEM, AND METHOD FOR MAXIMIZING ULTRAFINE MELTBLOWN FIBER ATTENUATION

(76) Inventors: Peter K. Herman, Stoughton, WI (US); James O. Stuart, Cookeville, TN (US); Yogeshwar K. Velu, Cookeville, TN (US)

Correspondence Address: Kunzler & McKenzie, 8 EAST BROADWAY, SUITE 600, SALT LAKE CITY, UT, 84111, US

(21) Appl. No.: 11/564,253

(22) Filed: Nov. 28, 2006

(51) Int. Cl. B29C 39/14

(52) U.S. Cl. 264/555; 425/72.2

(57) ABSTRACT

An apparatus, system and method to maximize ultrafine meltblown fiber attenuation. The nozzle apparatus includes a polymer streaming channel, at least one gas delivery channel, a restricted throat area, and a bounded expansion area. In some embodiments, the nozzle comprises a two-dimensional converging-diverging Laval nozzle geometry. The gas delivery channels may provide the gas under a pressure exceeding critical pressure, such that the gas achieves supersonic speeds at the restricted throat area. The bounded expansion area may stabilize such supersonic speeds, thus maximizing ultrafine meltblown fiber attenuation while minimizing the formation of fly and other defects.

### BACKGROUND OF THE INVENTION

1. Field of the Invention

This invention relates to meltblown fiber manufacture, and more particularly relates to systems and methods for maximizing ultrafine meltblown fiber attenuation.

2. Description of the Related Art

Meltblowing processes are highly effective to produce super-fine fibers on the micron or sub-micron scale. In general, meltblowing processes involve heating and extruding a thermoplastic fiber-forming polymer through tiny orifices in a meltblown die head. The molten polymer is then subjected to convergent streams of high velocity gas, such as air, to rapidly attenuate the polymer into microfibers having a diameter less than the diameter of the orifices in the die head. The gas has a temperature higher than or equal to the temperature of the molten polymer and is blown against the molten polymer in the direction of flow. In this manner, the high velocity gas also moves the resulting microfibers toward a collecting screen. The ambient air cools and solidifies the molten microfibers which are collected as a non-woven web on the collecting screen.

Meltblown non-woven webs have high insulating value, high cover per unit weight, and high surface area per unit weight. Accordingly, meltblown webs make excellent filtration media. Development of higher filter efficiencies at equal or even lower pressure drop, however, forces filter media development towards increasingly fine fiber diameters.

Current meltblown non-woven web manufacturing processes apply subsonic air velocities to attenuate the fibers, which generally limits meltblown fiber diameters to greater than about one micron (1μ). Although supersonic air velocities have been attempted in an effort to reduce fiber diameters, such velocities create violent, unstable attenuation forces. These forces cause the creation of “fly,” a defect consisting of short segments of very fine microfibers that break off from the continuous strand of molten polymer and are not collected by the collecting screen during laydown. While fly may not directly affect the quality of the web, it causes many other manufacturing problems by contaminating the surrounding production environment. In addition, fly may cause web non-uniformity by intermittently collecting on the web in “clumps” of agglomerated free-floating fibers.

Other existing sub-micron polymer fiber manufacturing technologies, such as solvent electrospinning methods, are very expensive, dangerous, and low-volume oriented.

Accordingly, a need exists for an ultrafine meltblown fiber production system that maximizes fiber attenuation and produces microfibers having reduced fiber diameters. Beneficially, such an ultrafine meltblown fiber production system would increase production efficiencies by reducing costs, enabling increased polymer throughput, and reducing the formation of fly. Such an ultrafine meltblown fiber production system is disclosed and claimed herein.

### SUMMARY OF THE INVENTION

The present invention has been developed in response to the present state of the art, and in particular, in response to the problems and needs in the art that have not yet been fully solved by currently available meltblown fiber production systems. Accordingly, the present invention has been developed to provide an ultrafine meltblown fiber production system that overcomes many or all of the above-discussed shortcomings in the art.

A nozzle apparatus to maximize ultrafine meltblown fiber attenuation in accordance with certain embodiments of the present invention includes a polymer streaming channel having an inlet and an outlet. The polymer streaming channel may direct a polymer therethrough in a direction from the inlet to the outlet. In some embodiments, the polymer includes a block co-polymer having a low viscosity and an increased melt strength. In other embodiments, the polymer includes a polyester, a polyamide, polyphenylene sulfide, and/or polypropylene.

One or more gas delivery channels may converge at a location substantially immediately adjacent to the channel outlet. The gas delivery channel may transport a gas under pressure to attenuate the polymer in a fiber attenuation zone. In some embodiments, the gas delivery channel may provide the gas under an elevated pressure, which results in sonic flow at the restricted convergence area and supersonic flow in the diverging section. Specifically, the pressure of the gas may be elevated such that a ratio of atmospheric pressure to the pressure is less than a critical pressure ratio for the gas.

A restricted throat area may restrict gas flow where the gas delivery channels converge such that the gas reaches supersonic speeds in the fiber attenuation zone. A bounded expansion area extending from the restricted throat area may stabilize the supersonic gas flow in the fiber attenuation zone. In certain embodiments, the shape and/or dimensions of the restricted throat area and bounded expansion area determines where a downstream shock may be positioned. The downstream shock may be positioned, for example, within the bounded expansion area, at an edge of the bounded expansion area, or beyond the bounded expansion area.

A system of the present invention is also presented to maximize ultrafine meltblown fiber attenuation. The system may be embodied by a storage device to store a polymer, a meltblowing die assembly to produce ultrafine meltblown fibers from the polymer, and a collection device to collect the ultrafine meltblown fibers.

The meltblowing die assembly includes a nozzle having a polymer streaming channel, at least one gas delivery channel, a restricted throat area, and a bounded expansion area. In some embodiments, the nozzle comprises a two-dimensional Laval nozzle geometry. As in the nozzle apparatus previously described, the gas delivery channels may provide the gas under a pressure such that a ratio of atmospheric pressure to the pressure (Pₐₜₘ/Pᵢₙₗₑₜ) is less than the critical pressure ratio. In this manner, the gas may achieve sonic velocity in the nozzle throat and supersonic velocity in the diverging section.

A method of the present invention is also presented for maximizing ultrafine meltblown fiber attenuation. In one embodiment, the method includes streaming a polymer through a channel, directing a flow of gas through at least one gas delivery channel, restricting the flow of gas, and directing the gas through a bounded expansion area. In some embodiments, the method may further include selecting a polymer having a low viscosity and a high melt strength, such as a block co-polymer.

As in the apparatus and system, the gas delivery channels may converge at a location substantially immediately adjacent to the channel outlet. The flow of gas through the channel may be provided under pressure such that a ratio of atmospheric pressure to the the pressure is less than a critical pressure ratio for the gas, resulting in sonic velocity in the nozzle throat and supersonic velocity in the diverging section. For example, in certain embodiments, the pressure may exceed about thirteen (13) psig.

The method may further comprise positioning a downstream shock downstream of the location where the gas delivery channels converge. In some embodiments, for example, the downstream shock may be positioned within the bounded expansion area, beyond the bounded expansion area, or at an edge of the bounded expansion area.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a perspective view of a prior art meltblowing system;

FIG. 2 is a diagram of gas flow through a conventional melt-blowing die;

FIG. 3 is a diagram illustrating supersonic gas velocity contours in a conventional melt-blowing die apparatus operating at a pressure above that required to achieve sonic (choked) flow in the converging section;

FIG. 4 is perspective view of a nozzle adapted to maximize ultrafine meltblown fiber attenuation in accordance with embodiments of the present invention;

FIG. 5 is a diagram illustrating velocity contours in a nozzle operating at a pressure above critical pressure in accordance with certain embodiments of the present invention; and

FIG. 6 is a graphical representation of velocity over distance for each of a conventional supersonic melt-blowing die apparatus and a nozzle in accordance with embodiments of the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are disclosed to provide a thorough understanding of embodiments of the present invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

As used in this specification, the term “Laval nozzle” refers to a convergent-divergent-type nozzle providing increased gas velocities in the divergent section of the nozzle, as is well known in the art for compressible gas flows. The term “fly” refers to “broken” short, fine fibers that fail to be incorporated in the forming web and become free-floating in the nearby area. The term “block co-polymer” refers to a polymer made up of blocks of polymerized monomer, where adjacent blocks comprise constitutional units derived from different species of monomer, or from the same species of monomer but with a different composition or sequence distribution of constitutional units.

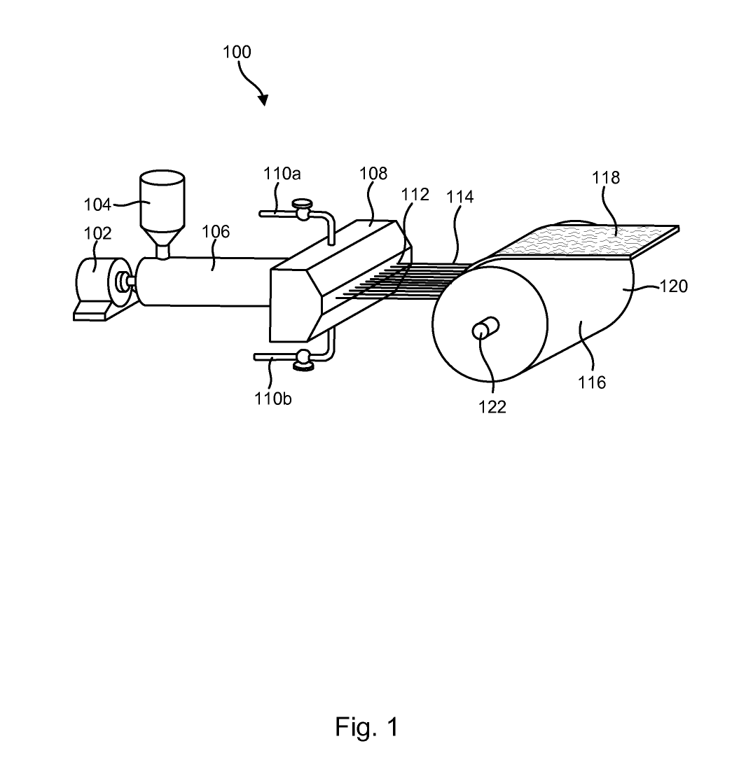

Referring now to FIG. 1, an apparatus and system for maximizing ultrafine meltblown fiber attenuation in accordance with the present invention may utilize a meltblowing system 100 for processing a polymer into meltblown microfibers 114. A typical meltblowing system 100 includes a drive motor 102, a polymer storage device 104 and extruder 106, a metering pump (not shown), a nozzle 108, and a collection device 116. In practice, polymer pellets or granules may be fed into the polymer storage device 104 and supplied to the extruder 106 by gravity feed. The extruder 106 may comprise a screw conveyer or any other device known to those in the art capable of conveying the polymer through the extruder 106. The extruder 106 may also melt the polymer by exposing it to incrementally higher temperatures. In certain embodiments, the extruder 106 comprises temperatures in a range between about one hundred sixty degrees Celsius and about two hundred thirty degrees Celsius (160° C.-230° C.). Such temperatures may melt the polymer to a substantially free-flowing state. The molten polymer may then be conveyed to a metering pump (not shown) to ensure a consistent and uniform flow of the polymer to the nozzle 108, where the polymer may stream through outlets 112 integrated therein.

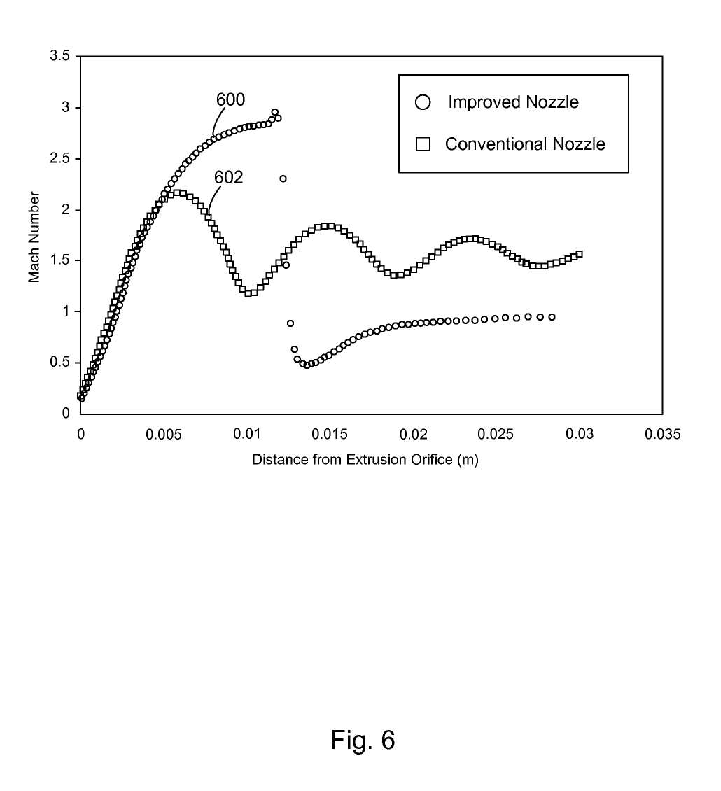

As discussed in more detail with reference to FIG. 6 below, while the meltblowing process is amenable to a wide range of polymers in terms of viscosities and blends, a polymer may be particularly selected to manifest a low viscosity and high melt strength. The polymer may thus be particularly suited to withstand high shear forces evidenced by certain embodiments of the present invention.

Polymer streaming channels (not shown) integrated into the nozzle 108 may channel the polymer through the nozzle 108 to the outlets 112. High velocity gas may flow through gas manifolds 110a, 110b and impinge the polymer upon exiting the outlets 112. Such high velocity gas streams attenuate the polymer to form fine microfibers 114. As the high velocity gas stream progresses towards a collection device 116, it carries the attenuated microfibers 114 with it. Ambient or secondary air cools and solidifies the attenuated microfibers 114, which may then collect randomly on the collection device 116 to form a non-woven web 118.

The collection device 116 may comprise a collecting screen 120, such as a perforated belt or drum, and a winder 122. In some cases, a vacuum may be applied to an inner surface of the collection screen 120 to enhance application of the microfibers 114 to the collection screen 120 surface.

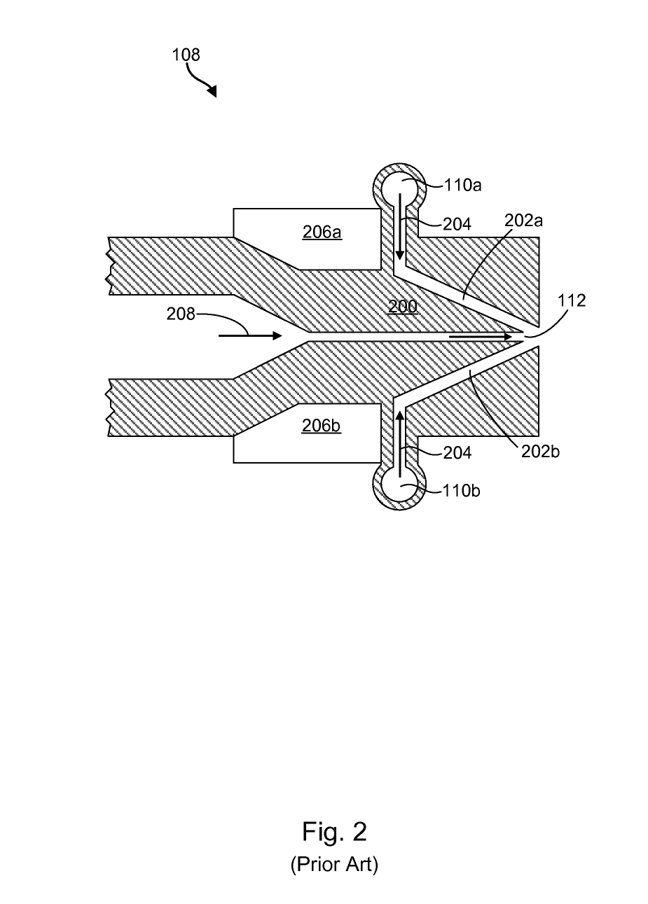

Referring now to FIG. 2, a conventional nozzle 108 may include several components including a polymer feed distribution system (not shown), a die nosepiece 200, and gas manifolds 110a, 110b. The polymer feed distribution system may provide substantially even polymer flow and residence time across the width of the nozzle 108 to facilitate polymer throughput and high product quality. The polymer feed distribution may comprise a T-type system, a coat hanger-type system, or any other polymer feed distribution system known to those in the art.

The die nosepiece 200 may comprise a tapered piece of hard metal, or any other suitable material known to those in the art. The die nosepiece 200 may include multiple outlets (orifices) 112 integrated across the length of its tapered edge. A typical die nosepiece 200 includes approximately 0.4 mm diameter outlets 112 spaced at one-tenth to four millimeters (0.1-4 mm). The outlets 112 may comprise drilled hole-type orifices or capillary-type orifices, may be offset from or aligned with each other, and may include any cross-sectional shape known to those in the art.

Gas manifolds 110a, 110b may direct a flow of high velocity gas 204, usually hot air, into gas delivery channels 202a, 202b on either side of the die nosepiece 200. The high velocity gas 204 may stream through the gas manifolds 110a, 110b and associated gas delivery channels 202a, 202b to attenuate the polymer 208 into microfibers 114, as discussed above. In some embodiments, heating elements 206a, 206b may be disposed substantially adjacent the die nosepiece 200 to facilitate polymer throughput by further heating the polymer 208 to low viscosity.

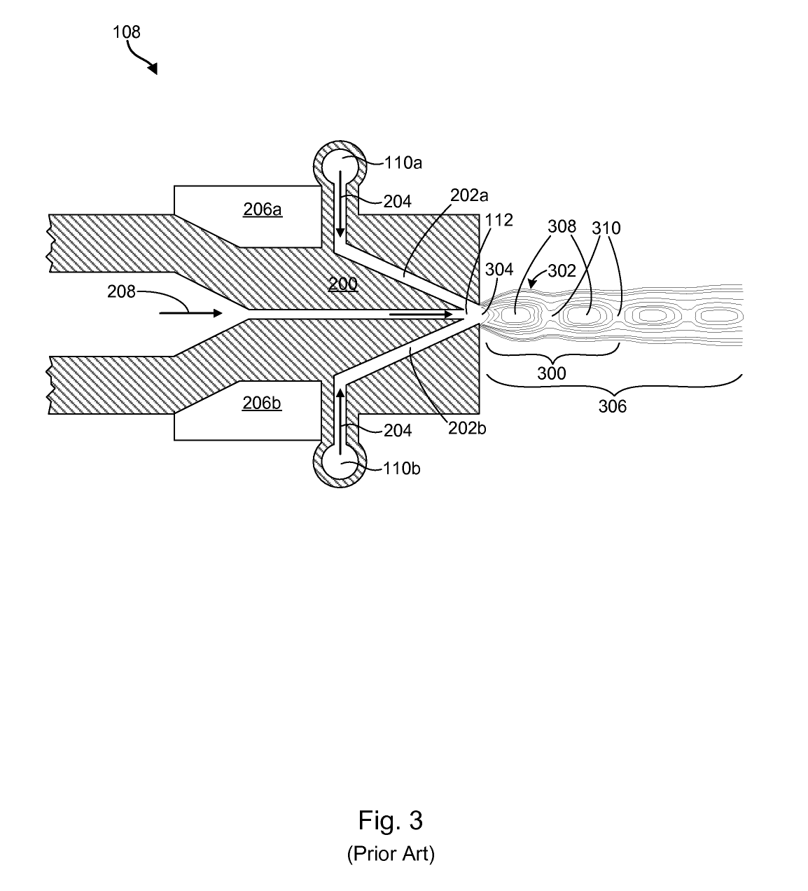

Referring now to FIG. 3, gas flow 204 through the gas delivery channels 202a, 202b may converge at a location substantially immediately adjacent an outlet 112. This gas convergence point 304 may mark the beginning of a fiber attenuation zone 300, the distance over which microfibers 114 may be attenuated from the exiting polymer 208. In some embodiments, the fiber attenuation zone 300 comprises a distance of about ten millimeters (10 mm) from the outlet 112.

In conventional meltblowing systems, subsonic velocity gas flow 204 through the gas delivery channels 202a, 202b and in the fiber attenuation zone 300 causes rapid polymer attenuation. Typical subsonic velocities comprise 0.5 to 0.8 the speed of sound (Mach 0.5-0.8). Microfibers 114 formed in this manner may comprise fiber diameters ranging between about one and about seven micrometers (1-7 μm).

Stable subsonic velocity gas flow 204 as discussed above maybe achieved by providing the gas at a pressure where a ratio of atmospheric pressure to gas pressure is greater than a critical pressure ratio for the gas. A critical pressure ratio may be defined by the equation: [p2/p1]_{c}=[2/(k+1)]^{kk-1}, where p2 is equal to the outlet pressure, p1 equals the inlet pressure, and k equals the specific heat ratio (cp/cv). For air, the specific heat ratio k is equal to 1.4. Accordingly, the critical pressure ratio for air is 0.53. The gas pressure in the gas delivery channels 202a, 202b must therefore be maintained at less than about thirteen (13) psig to achieve stable subsonic velocity gas flow 204 in the fiber attenuation zone 300.

For supersonic velocity gas flow 204 in the fiber attenuation zone 300, gas pressure in the gas delivery channels 202a, 202b must be maintained above about thirteen (13) psig, such that a ratio of atmospheric pressure to gas pressure is less than the critical pressure ratio for air, or 0.53. Indeed, gas pressure maintained at greater than about thirteen (13) psig may result in sonic flow at the convergence area and supersonic flow in the diverging section.

FIG. 3 illustrates air velocity contours 302 resulting from a gas pressure of about fifty-eight (58) psig in a conventional meltblowing nozzle 108. At this pressure, gas flow 204 becomes choked (i.e. achieves sonic velocity) at the convergence point 304 and then undergoes a series of uncontrolled oscillating supersonic 308/transonic 310 velocity excursions in the abrupt unbounded expansion area 306. While supersonic velocities are thus achieved, the wild oscillations of velocity in the fiber attenuation zone 300 are undesirable as they cause the fibers to break apart and create fly.

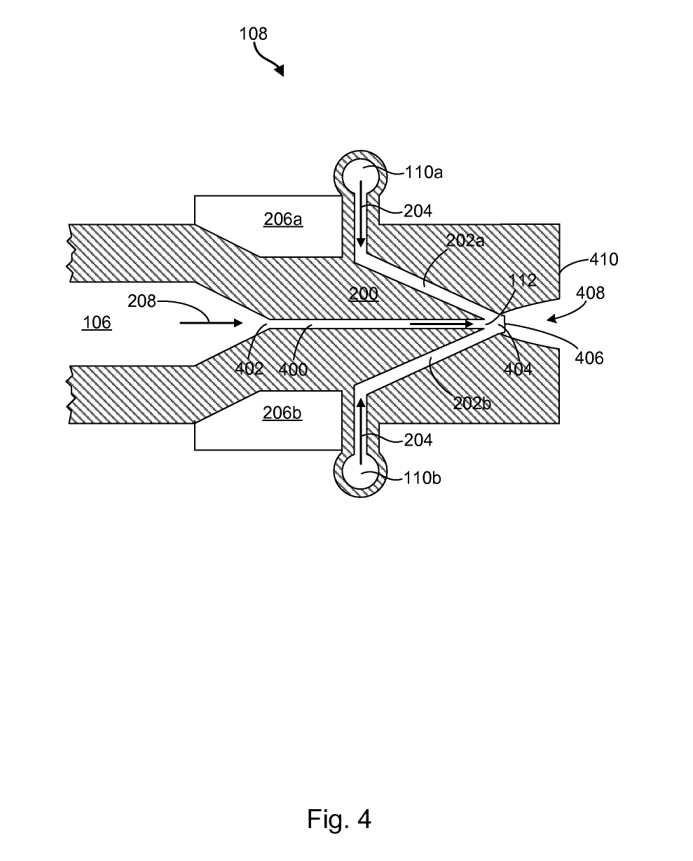

Referring now to FIG. 4, a nozzle 108 for maximizing ultrafine meltblown fiber attenuation in accordance with the present invention enables attenuation of ultrafine meltblown fibers at stable supersonic velocities. Specifically, the nozzle 108 may include at least one polymer streaming channel 400 having an inlet 402 and an outlet 112. The polymer streaming channel 400 may accommodate a flow of molten polymer in a direction from the inlet 402 to the outlet 112. In some embodiments, the polymer streaming channel 400 may communicate with an upstream extruder 106 and storage device 104 in a meltblowing system 100. As discussed above, the polymer streaming channel 400 outlet 112 may comprise a hole or orifice having any cross-sectional shape known to those in the art. The outlet 112 may further be angled away from or aligned with the polymer streaming channel 400.

The nozzle 108 of the present invention may further include at least one gas delivery channel 202a, 202b to carry a flow of gas from a gas manifold 110a, 110b to a location 404 substantially immediately adjacent to the outlet 112. The flow of gas may comprise hot air, or any other gas known to those in the art. In some embodiments, two gas delivery channels 202a, 202b situated on either side of the polymer streaming channel 400 converge at the location 404. Gas may be directed through the gas delivery channels 202a, 202b at high velocity to attenuate a polymer exiting the polymer streaming channel 400 outlet 112.

In this manner, the location 404, and in some embodiments a convergence point 304 of the gas delivery channels 202a, 202b, marks the beginning of a fiber attenuation zone 300. The fiber attenuation zone 300 may extend about ten millimeters (10 mm) or more from the location 404, after which the attenuated microfiers 114 may be carried by the flow of gas to a downstream collection device 116.

The nozzle 108 may further include a restricted throat area 406 substantially corresponding to the location 404. A bounded expansion area 408 may be provided downstream of the restricted throat area 406, such that the nozzle 108 substantially reflects a two-dimensional converging-diverging Laval nozzle geometry. In practice, the restricted throat area 406 may operate to accelerate a flow of gas to sonic speeds. At the restricted throat area 406, where the cross-sectional area is at a minimum, the gas velocity may become locally sonic, a condition known as “choked flow.” As previously mentioned, a ratio of atmospheric pressure to gas pressure at this point must be maintained at less than a critical pressure of about 0.53 where the gas is air. As the cross-sectional area of the nozzle 108 increases in the bounded expansion area 408, the gas expands and the gas flow may increase to supersonic velocities.

A downstream shock (not shown) occurs where the gas flow transitions from supersonic speeds abruptly back to subsonic speeds. The downstream shock may also mark an abrupt temperature change, as discussed in more detail below.

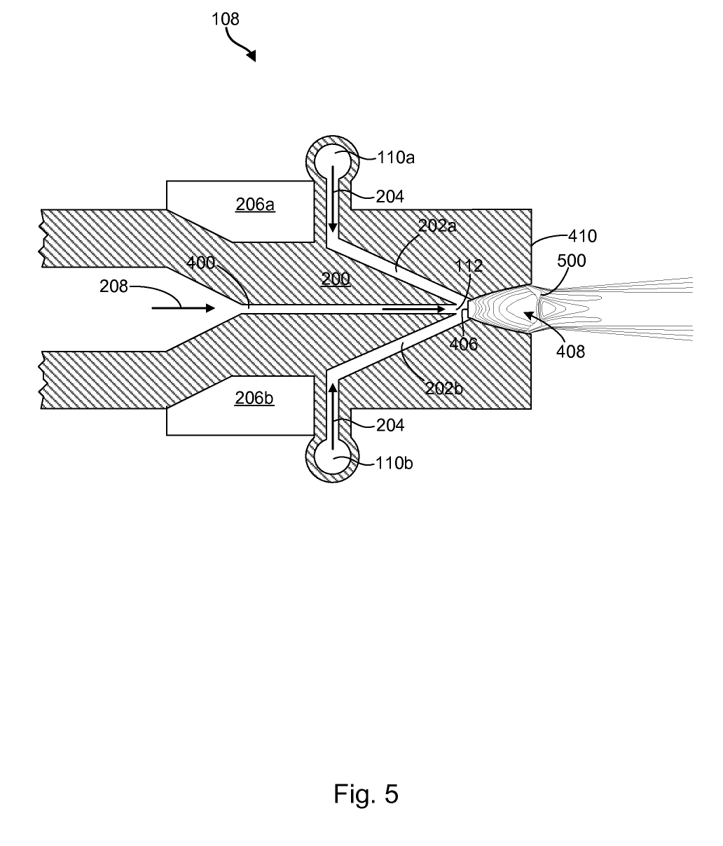

As discussed in more detail with reference to FIG. 5 below, the nozzle 108 may be designed to particularly position the downstream shock to substantially correspond to a terminal boundary 410 of the bounded expansion area 408, to a location beyond the terminal boundary 410, or to a location within the bounded expansion area 408. Specifically, the dimensions of the gas delivery channels 202a, 202b, restricted throat area 406 and bounded expansion area 408 may be selectively varied to alter the location of the downstream shock, as is well known in the art, such as in rocket nozzle design.

Referring now to FIG. 5, in certain embodiments, the downstream shock 500 may be positioned at a terminal boundary 410 of the bounded expansion area 408 such that microfibers 114 may be substantially fully attenuated at supersonic speeds, and thus evidence reduced fiber diameters. Decreased fiber diameters offer improved filtration performance (efficiency, pressure drop, etc), as is well established by filtration theory.

Further, the bounded expansion area 408 may function to quell the wild oscillation evidenced by prior art supersonic attenuation devices. The benefits of this function may be more fully realized by situating the downstream shock 500 downstream of the bounded expansion area 408 to provide stable supersonic velocities in the fiber attenuation zone 300. In this manner, formation of fly and ropes in the resulting non-woven web 118 may be reduced.

In other embodiments, a downstream shock 500 position may be varied according to temperature considerations. For example, an extreme drop in static temperature may occur where the gas flow reaches supersonic speeds. In one embodiment, for example, a temperature at the restricted throat area 406 jumps from about 270° C. to about −63° C. where the gas flow becomes supersonic. This sudden drop in temperature may be useful to achieve unique effects not before possible.

For example, in certain embodiments the sudden drop in temperature occurring at supersonic speeds may be useful at a distance removed from the polymer streaming channel 400 outlet 112 to freeze or crystallize the attenuated microfibers 114. Specifically, the dimensions of the gas delivery channels 202a, 202b, restricted throat area 406, and bounded expansion area 408 may be varied with respect to each other to achieve supersonic gas flow at a location between about five and about ten millimeters (5-10 mm) downstream of the outlet 112. In this manner, the nozzle 108 of the present invention may create a subsonic fiber attenuation zone 300 prior to the gas flow reaching supersonic speeds, and then freeze or crystallize the attenuated microfibers 114 where the gas flow reaches supersonic speeds. Such gas flow characteristics may create non-woven webs 118 with a bimodal or multimodal fiber diameter distribution. In other embodiments, such gas flow may create microfibers 114 having fiber diameters with reduced size deviation from the mean (geometric standard deviation). Further, in some embodiments, the temperature drop occurring at supersonic gas speeds may help to rapidly quench microfibers 114 and thus decrease the incidence of fiber breakage and creation of fly.

In certain embodiments, the collection device 116 may be positioned substantially immediately downstream from the shock 500. The abrupt jump back to high temperatures that may correspond to the shock 500 may further attenuate the microfibers 114 prior to collection by the collection device 116. In this manner, the nozzle 108 of the present invention may be used to produce sub-micron fibers 114.

Referring now to FIG. 6, the nozzle 108 of the present invention may enable both increased supersonic velocities and increased stability at supersonic speeds relative to a conventional nozzle 108 achieving supersonic gas velocities. As shown in FIG. 6, for example, gas pressures in the gas delivery channels 202a, 202b for each of the nozzle 108 of the present invention and the conventional nozzle 108 may be maintained at fifty-eight pounds per square inch (58 psig) to achieve supersonic speeds at a location substantially corresponding to the polymer streaming channel 400 outlet 112.

While gas velocities may steadily increase at approximately the same rates for both the present nozzle 108 and the conventional nozzle 108 for a distance of approximately 0.005 m from the outlet 112, velocities 602 may top out at approximately Mach 2 for the conventional nozzle 108, while velocities 600 may climb to almost Mach 3 for the present nozzle 108. The nozzle 108 of the present invention may thus demonstrate increased gas velocities 600 with respect to the conventional nozzle 108.

The present nozzle 108 may also demonstrate increased supersonic velocity stability with respect to the conventional nozzle 108. While the conventional nozzle 108 may evidence uncontrolled oscillating supersonic 308/transonic 310 velocity excursions at distances greater than about 0.005 m from the polymer streaming channel 400 outlet 112, the nozzle 108 of the present invention may maintain substantially stable velocities 600 over the entire distance, and minimized oscillation in the downstream unbounded exhaust zone, at a distance greater than about 0.013 m for this specific case.

Specially designed and/or selected polymers, including block co-polymers, may prove advantageous in their ability to withstand the increased gas velocities 600 and high shear forces evidenced by the nozzle 108 in accordance with certain embodiments of the present invention. Specifically, block co-polymers may evidence low melt viscosities (similar to their homopolymer counterparts) above their order/disorder transition temperatures (T_{ODT}). Upon cooling below their T_{ODT}, self-assembly of a block copolymer can produce a rapid and dramatic increase in melt strength.

A desired melt strength may be achieved and/or adjusted by varying material attributes such as block length, composition, number of blocks, and/or any other material attribute known to those in the art. Additional increases in melt strength can by achieved by crystallization of one or more of the blocks. Achieving a desired melt strength in this manner may reduce the formation of fly fibers which, as mentioned above, may prove detrimental to filter media production efficiencies.

In addition, ordering of the block co-polymer in the molten state may produce microfibers 114 having increased strength relative to microfibers 114 produced from the block co-polymer's individual homopolymer constituents. Use of selected block co-polymers in connection with the nozzle 108 of the present invention may thus decrease an incidence of fly formation and contribute to increased mechanical strength in a resulting non-woven web 118.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A nozzle for maximizing ultrafine meltblown fiber attenuation, comprising:
a polymer streaming channel having an inlet and an outlet;
at least one gas delivery channel converging at a location substantially immediately adjacent to the outlet to form a fiber attenuation zone;
a restricted throat area to restrict gas flow at the location, the restricted throat area adapted to achieve choked sonic flow; and
a bounded expansion area extending from the restricted throat area to stabilize supersonic gas flow in a fiber attenuation zone.

2. The nozzle of claim 1, wherein the polymer streaming channel streams a polymer in a direction from the inlet to the outlet.

3. The nozzle of claim 2, wherein the at least one gas delivery channel transports gas under pressure to attenuate the polymer in the fiber attenuation zone.

4. The nozzle of claim 3, wherein a ratio of atmospheric pressure to gas delivery channel pressure is less than a critical pressure ratio for the gas.

5. The nozzle of claim 3, wherein the pressure is greater than about 13 psig.

6. The nozzle of claim 2, wherein the polymer is selected from the group consisting of a block co-polymer, a polyester, a polyamide, polyphenylene sulfide and polypropylene.

7. The nozzle of claim 1, wherein dimensions of each of the restricted throat area and the expansion zone determine a shock position.

8. The nozzle of claim 7, wherein the shock position is selected from the group consisting of within the bounded expansion area, at an edge of the bounded expansion area, and beyond the bounded expansion area.

9. A system for maximizing ultrafine meltblown fiber attenuation, comprising:
a storage device to store a polymer;
a meltblowing die assembly to produce ultrafine meltblown fibers from the polymer, the meltblowing die assembly including a nozzle comprising:
a polymer streaming channel having an inlet and an outlet;
at least one gas delivery channel converging at a location substantially immediately adjacent to the outlet;
a restricted throat area to restrict gas flow at the location, the restricted throat area adapted to achieve choked sonic flow; and
a bounded expansion area extending from the restricted throat area to stabilize supersonic gas flow in a fiber attenuation zone; and
a collection device to collect the ultrafine meltblown fibers downstream of the fiber attenuation zone.

10. The system of claim 9, wherein the polymer is selected from the group consisting of a block co-polymer, a polyester, a polyamide, polyphenylene sulfide and polypropylene.

11. The system of claim 9, wherein a ratio of atmospheric pressure to gas delivery channel pressure is less than a critical pressure ratio for the gas.

12. The system of claim 9, wherein a downstream shock is positioned at an edge of the bounded expansion area.

13. The system of claim 9, wherein the nozzle comprises a two-dimensional converging-diverging Laval nozzle geometry.

14. A method for maximizing ultrafine meltblown fiber attenuation, comprising:
streaming a polymer through a channel having an inlet and an outlet;
directing a flow of gas through at least one gas delivery channel, the at least one gas delivery channel converging at a location substantially immediately adjacent to the outlet;
restricting the flow of gas at the location to achieve choked sonic flow;
and
directing the gas through a bounded expansion area downstream of the location to stabilize a supersonic gas flow.

15. The method of claim 14, further comprising selecting a polymer having a low viscosity and a high melt strength.

16. The method of claim 15, wherein selecting further comprises providing a polymer selected from the group consisting of a block co-polymer, a polyester, a polyamide, polyphenylene sulfide and polypropylene.

17. The method of claim 14, wherein directing the flow of gas through the at least one gas delivery channel comprises providing the gas at a pressure wherein a ratio of atmospheric pressure to the pressure is less than a critical pressure ratio for the gas.

18. The method of claim 17, wherein the pressure exceeds about 13 psig.

19. The method of claim 14, further comprising positioning a downstream shock downstream of the location.

20. The method of claim 19, wherein positioning the downstream shock comprises positioning the downstream shock at one of within the bounded expansion area, beyond the bounded expansion area, and at an edge of the bounded expansion area.
